(19) United States
(12) Patent Application Publication
(10) Pub. No.: US 2013/0015381 A1
(43) Pub. Date: Jan. 17, 2013

(54) Electrically-Actuated Valve Having Manual Override

(71) Applicant: Charles Bernard Husick, Tierra Verde, FL (US)

(72) Inventor: Charles Bernard Husick, Tierra Verde, FL (US)

(21) Appl. No.: 13/183,513

(22) Filed: Jul. 15, 2011

(51) Int. Cl. F16K 31/524

(52) U.S. Cl. 251/251

(57) ABSTRACT

The present invention comprises a valve, such as a ball valve as is typically employed as a through-hull valve on a vessel, equipped with a handle for manual operation, and further equipped with an electric drive capable of opening and closing the valve upon receipt of a control signal. The valve of the present invention also incorporates a status sensor and transmitter capable of reporting the current status of the valve and its associated drive system. Preferably, the valve of the present invention also incorporates a power source, such as a battery, capable of operating the electric drive in the event that power from an external source becomes unavailable.

### BACKGROUND OF THE INVENTION

Electrically actuated valves are not a new concept; opening a closed valve or closing an open valve with the touch of a button from a remote location has long been convenient and desirable. As a result, valves having motor drives have long been used in the manufacturing industry, in the marine industry, and in other application areas to provide both mechanical power where valve actuation by human power was inconvenient or impossible, and remote operation.

It has long been recognized that an electrically operated valve must have a manual override capability, but the methods for achieving manual operation are not intuitive, and the procedure is physically difficult, time consuming, and often requires the use of tools. Furthermore, in a system that includes multiple valves, often in multiple sizes, such as on a marine vessel, monitoring and controlling the valves presents additional challenges to the designer and operator, alike.

### BRIEF DESCRIPTION OF THE INVENTION

The present invention comprises a valve, such as a ball valve as is typically employed as a through-hull valve or seacock on a marine vessel, equipped with a handle for manual operation, and further equipped with an electric drive capable of opening and closing the valve upon receipt of a control signal. The valve of the present invention also incorporates multiple status sensors and a transmitter capable of reporting the current status of the valve and its associated drive system. Preferably, the valve of the present invention also incorporates a power source, such as a battery, capable of operating the electric drive in the event that power from an external source becomes unavailable.

The valve of the present invention may be manually operated from either the open to the closed position, or from the closed to the open position by actuation of the handle, without any prior adjustment of the valve or electric drive, and without the use of tools or disengagement of the electric drive from the valve itself. In this way, emergency or manual operation is intuitive (being exactly like operation of prior-art, non-motorized valves) and fast (without requiring the operations prior to manual actuation that are common in prior-art powered valve systems.) The ability to quickly open or close the valve by manually manipulating the control handle may be critical for the safe operation of vessel systems and for over-all integrity of the vessel.

### BRIEF DESCRIPTION OF THE FIGURES

FIG. 1 depicts in perspective view, the valve of the present invention in its open position.

FIG. 2 depicts in semi-transparent perspective view, the valve of the present invention in its open position.

FIG. 3a depicts the drive cam of the present invention, in “ready” position.

FIG. 3b depicts the drive cam of the present invention in “counterclockwise” position.

FIG. 3c depicts the drive cam of the present invention in “clockwise” position

FIG. 4 depicts a block diagram of the control sequence of the present invention.

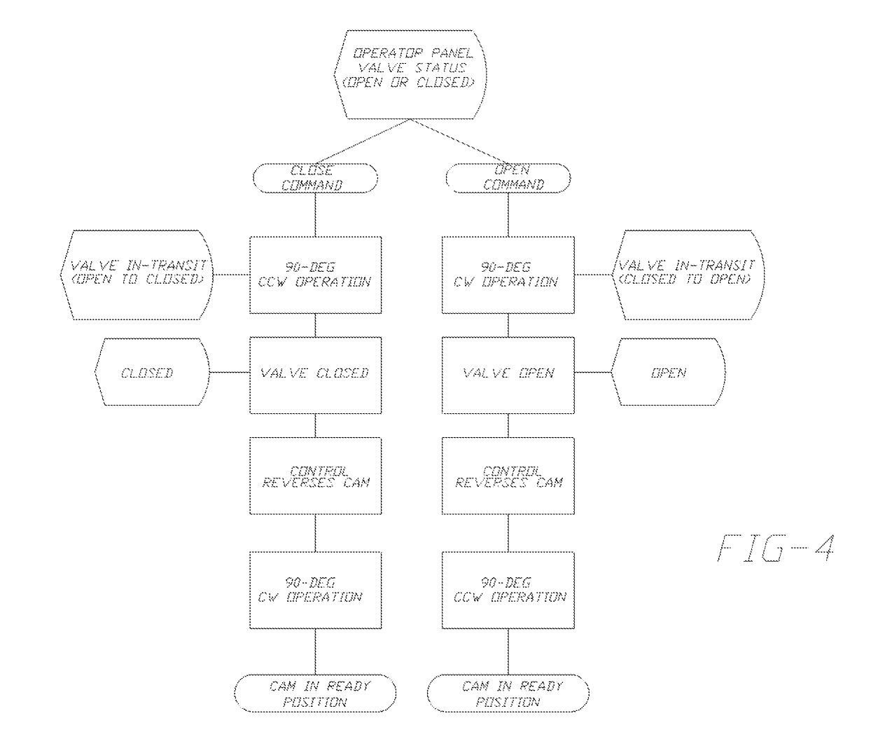

FIG. 5a depicts a control panel for a system comprised of a plurality of valves of the present invention, showing all valves status as closed.

FIG. 5b depicts a control panel for a system comprised of a plurality of valves of the present invention, showing all valves status as open.

FIG. 5c depicts a control panel for a system comprised of a plurality of valves of the present invention, showing some valves status as open, and showing the remaining valves status as closed.

FIG. 6 depicts in perspective view, the valve of the present invention in its closed position.

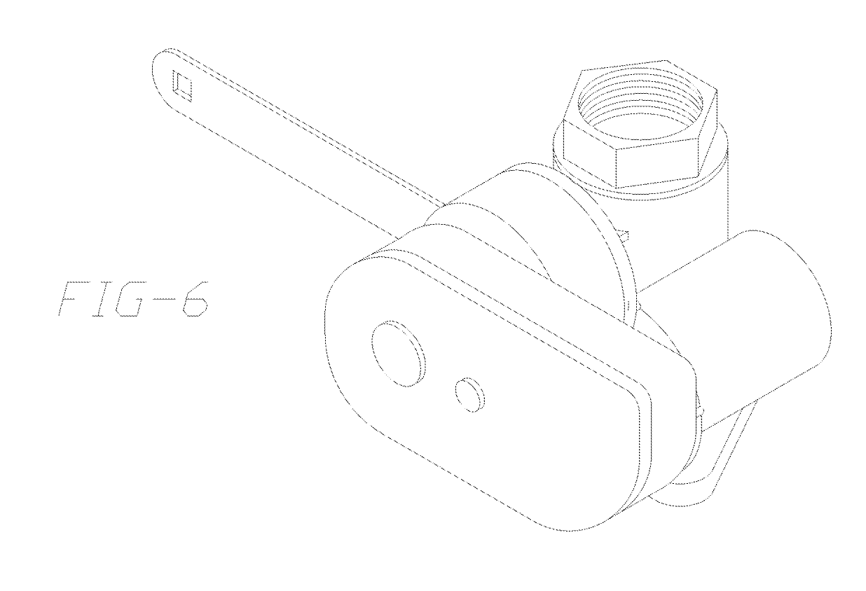

FIG. 7 depicts in semi-transparent perspective view, the valve of the present invention in its closed position.

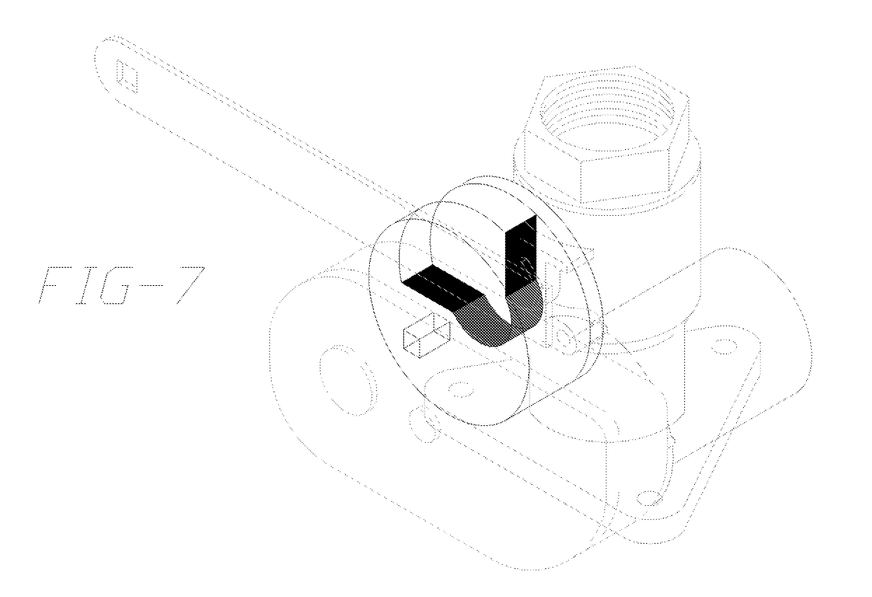

### DETAILED DESCRIPTION OF THE INVENTION

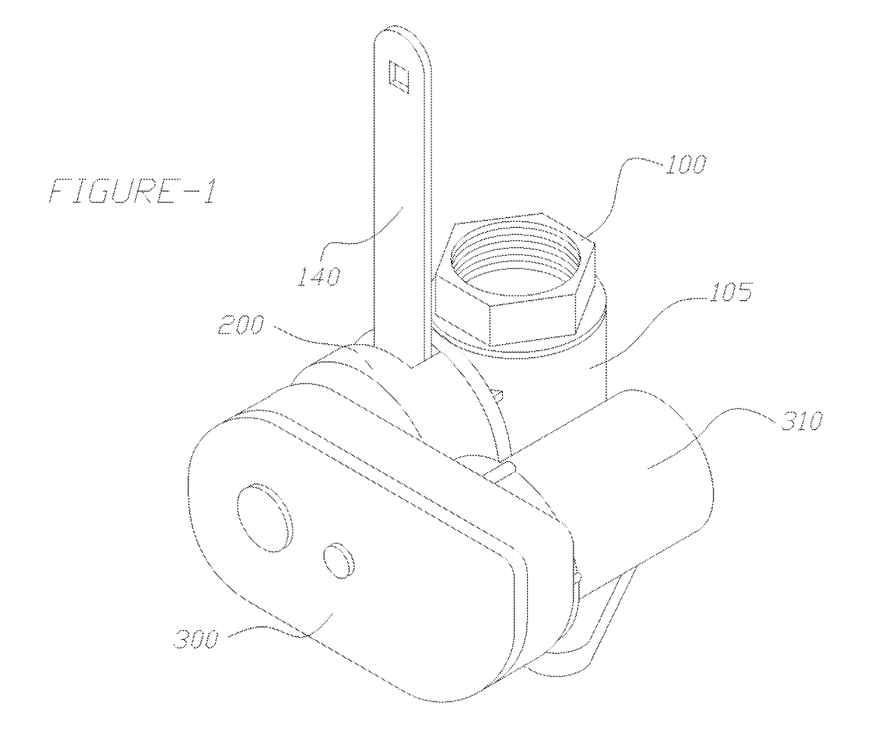

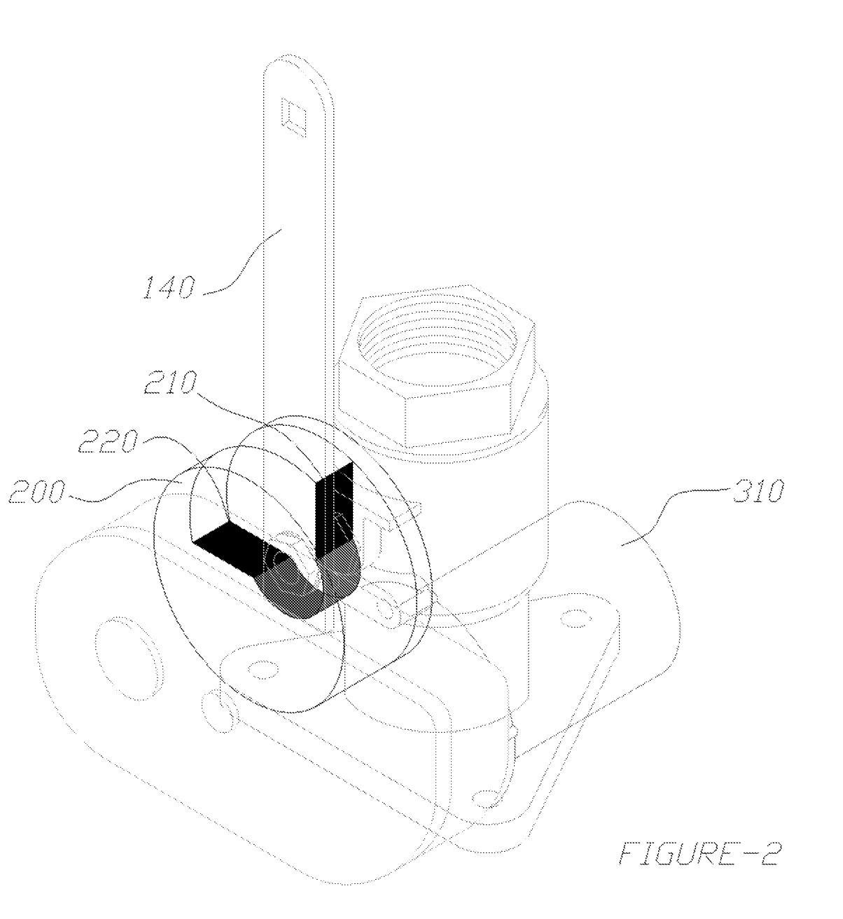

Referring now to FIGS. 1 and 2, there is shown in perspective view, the valve 100 of the present invention. Hollow valve body 105 contains a ball element 110 (not shown) having an aperture 120 (not shown) therethrough, and situated in a seat 115 (not shown). Ball element 110 further has an actuation axle 130 (not shown) attached at a right angle to the longitudinal axis of aperture 120. Axle 130 is connected to handle 140. Preferably, handle 140's long axis is aligned with the longitudinal axis of aperture 120, so that, in operation, the position of handle 140 provides both tactile and visual indication of the state of valve 100 (with a vertical handle signifying an open valve, and a horizontal handle signifying a closed valve.)

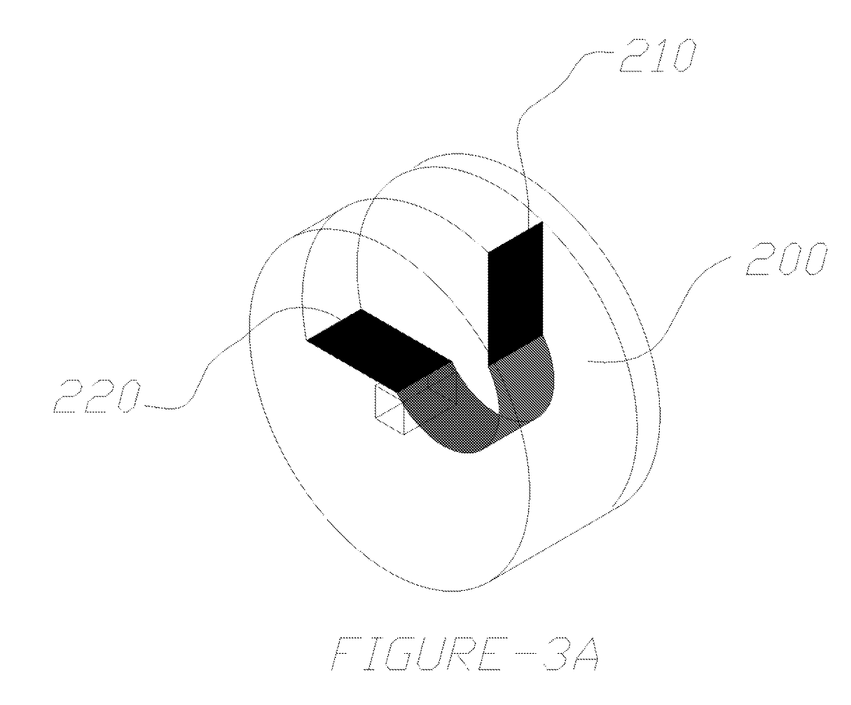

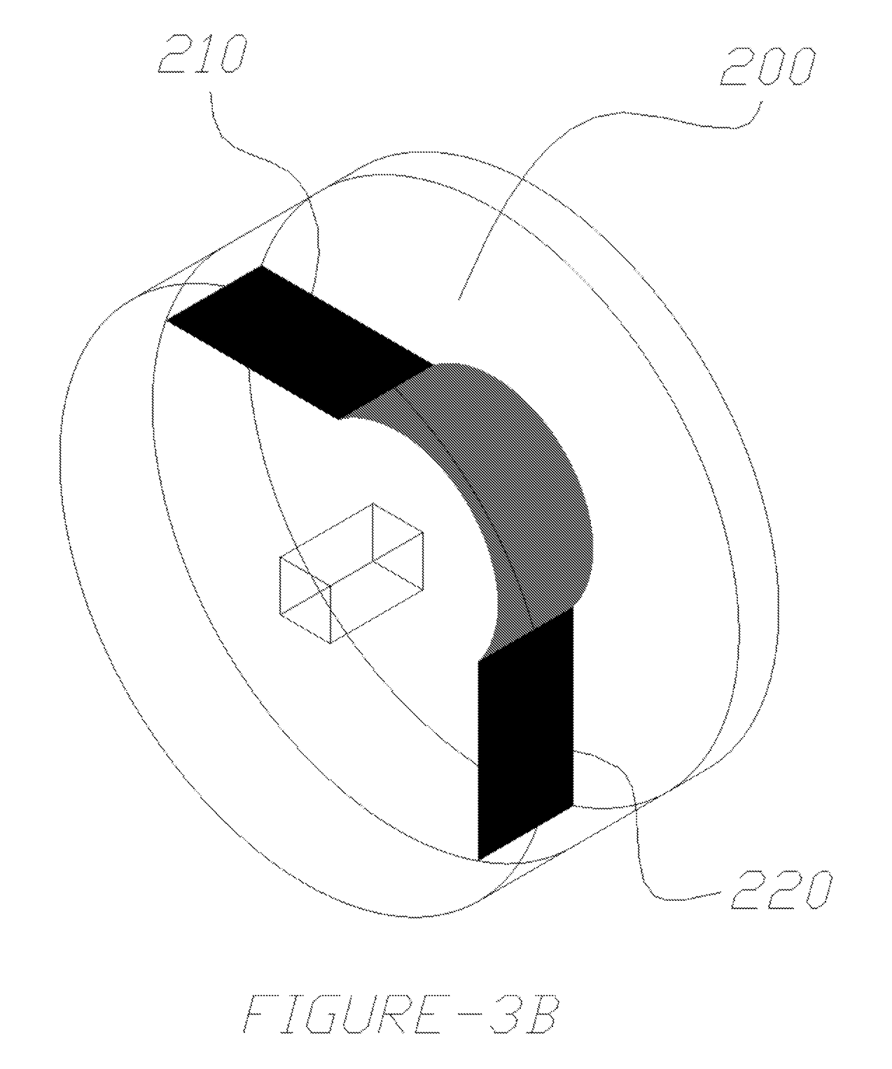

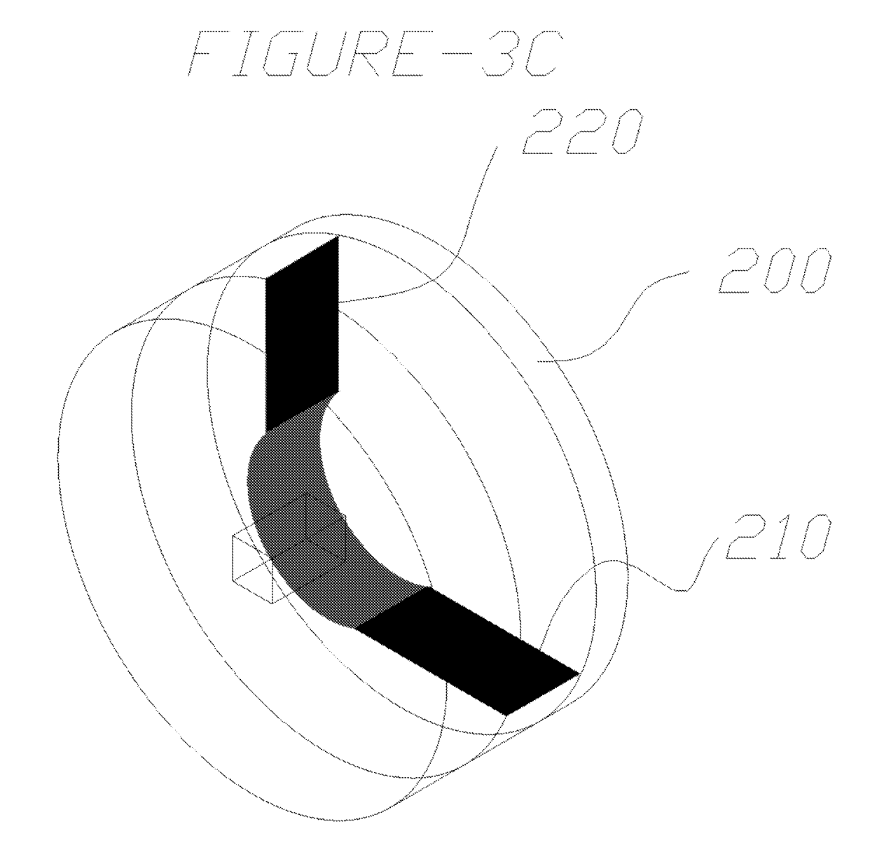

On the side of handle 140 is situated actuation cam 200 (also shown in FIGS. 3a, 3b and 3c.) Cam 200 is provided with first and second cam faces 210 and 220, which are disposed with respect to each other at approximately right angles. Cam 200 is positioned in such a manner that cam faces 210 and 220 may be brought into contact with opposite edges of handle 140 as a result of rotation of cam 200. Cam 200 is preferably driven by a central shaft 230 (not shown), which may be driven by an external source of motive power. (Of course, axle 130 may merely be extended through handle 140 as a substitute for shaft 230.) Alternatively, cam 200 may be provided with circumferential gear teeth (not shown) which may be engaged to provide a source of motive power. As a further alternative, cam 200 may be provided with circumferential means for engaging a drive belt (not shown), which may be driven by an external source of motive power.

In a preferred embodiment, shaft 230 protrudes from a gear box 300, arranged to provide reduction gearing to match the rotational speed and torque of a motor 310 to the desired actuation speed and force necessary to operate valve 100 by rotation of handle 140 though a 90° arc. The preferred embodiment uses a small direct current motor, having a rotational speed of between 7,000 and 20,000 rpm. (For example, a Mabuchi RS-365PH or similar motor may be employed. Such motors are characterized by their high rotational velocity and low power requirements.) Reduction gears in gear box 300 reduce this rotational speed to from 1 to 3 rpm, so that handle 140 undergoes full displacement in 15 seconds or less. Of course, depending on the power required to actuate valve 100, and the desired operational cycle time, other motors and drive arrangements may be employed, as necessary.

Control circuit 400 is capable of actuating motor 310 in either rotational direction, to either open or close valve 100 by rotation of cam 200 in a clockwise or counterclockwise direction. Alternately, circuit 400 may actuate a reversing element in gear box 300 in order to reverse the direction of rotation of cam 200. As an alternative embodiment, gear box 300 may incorporate a mechanical reversing element, actuated by full rotation of cam 200 (or of shaft 230) from one limit of its travel to the other.

Control circuit 400 is preferably embedded within cam 200 and is equipped with one or more sensors to detect the position of shaft 230, axle 130, handle 140 and/or ball 110, as well as the failure of the motor 310 or gear box 300. Further, control 400 detects the need to replace the battery of its internal power supply, and alerts the vessel operator thereto. Following a valve closure or opening, the control circuit 400 commands cam 200 to return to the “ready position” (FIG. 3A).

In operation, control circuit 400 receives a signal to actuate valve 100 from control panel 500. This signal may be a simple command to change state (i.e., from closed to open, or from open to closed) or it may be a command to either open or close valve 100. In the case of a command to change state from closed to open, or simply to open valve 100, control circuit 400 energizes motor 310 and engages gear box 300 to rotate cam face 220 of cam 200 from its “ready” position through an arc of 90° clockwise, bringing handle 140 to a vertical position, and aligning aperture 120 with valve body 105 to permit fluid to flow through the valve. Immediately upon reaching this position, control circuit 400 reverses motor 310 and gear box 300 and rotates cam 200 through 90° counterclockwise to return cam 200 to its “ready” position. By so-doing, handle 140 is left completely free for manual rotation to the closed position without interference from cam 200, and thus, full manual operation of valve 100 is permitted without disengaging the drive elements, and without tools or special operations.

Similarly, in the case of a command to change state from open to closed, or simply to close valve 100, control circuit 400 energizes motor 310 and engages gear box 300 to rotate cam face 210 of cam 200 from its “ready” position through an arc of 90° counterclockwise, bringing handle 140 to a horizontal position, and aligning aperture 120 at right angle to valve body 105 to inhibit fluid to flow through the valve. Immediately upon reaching this position, control circuit 400 reverses motor 310 and gear box 300 rotates cam 200 through 90° clockwise to return cam 200 to its “ready” position. By so-doing, handle 140 is left completely free for manual rotation back to the open position without interference from cam 200, and thus, full manual operation of valve 100 is permitted without disengaging the drive elements, and without tools or special operations.

Optionally, an auxiliary power source, such as a 9VDC battery, may be incorporated into gear box 300, along with a means for sensing the unavailability of externally-supplied power. Thus in cases of power failure, there would then exist the ability to control valve 100 (preferably in order to electrically close it in an emergency situation.) In addition, a control switch or switches (not shown) may be provided local to valve 100 (such as on the gear box housing, motor housing, or in a similar location) to allow actuation of control circuit 400.

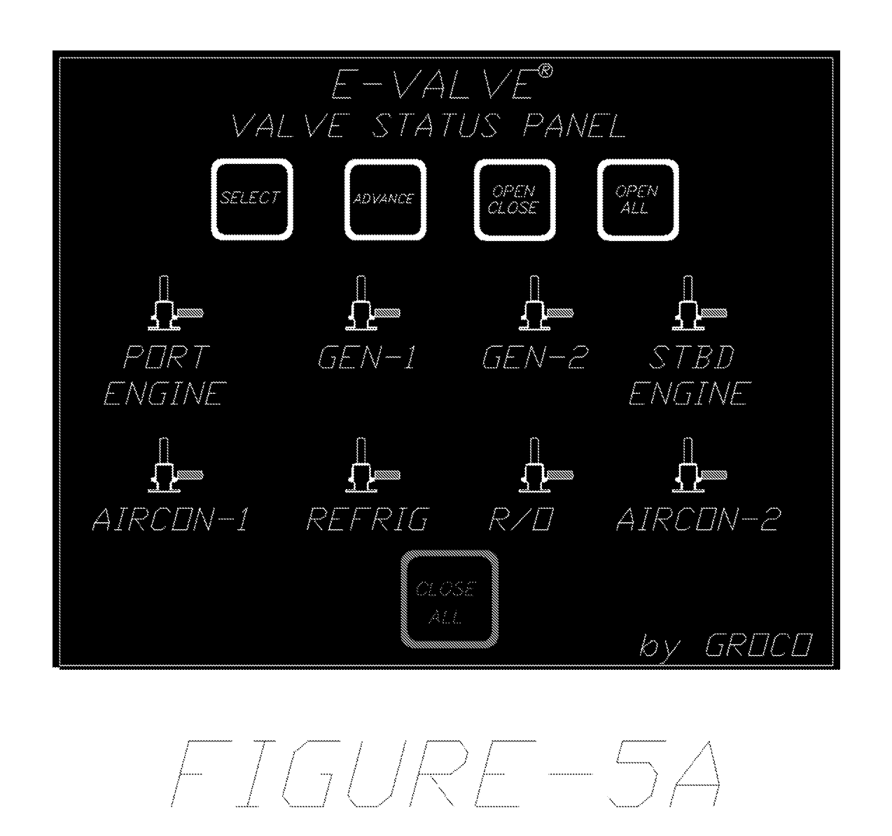

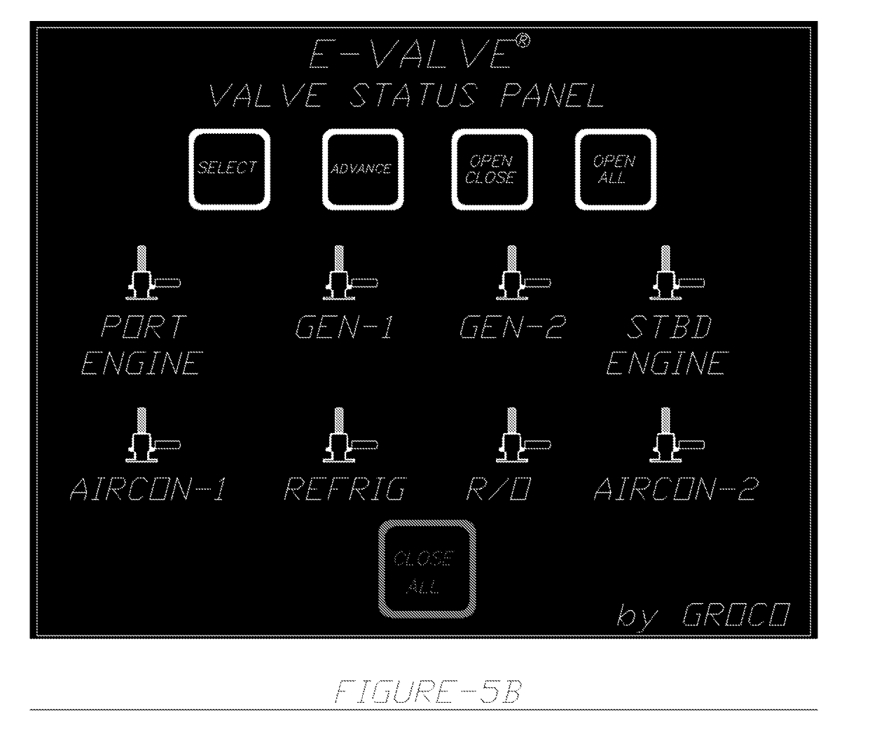

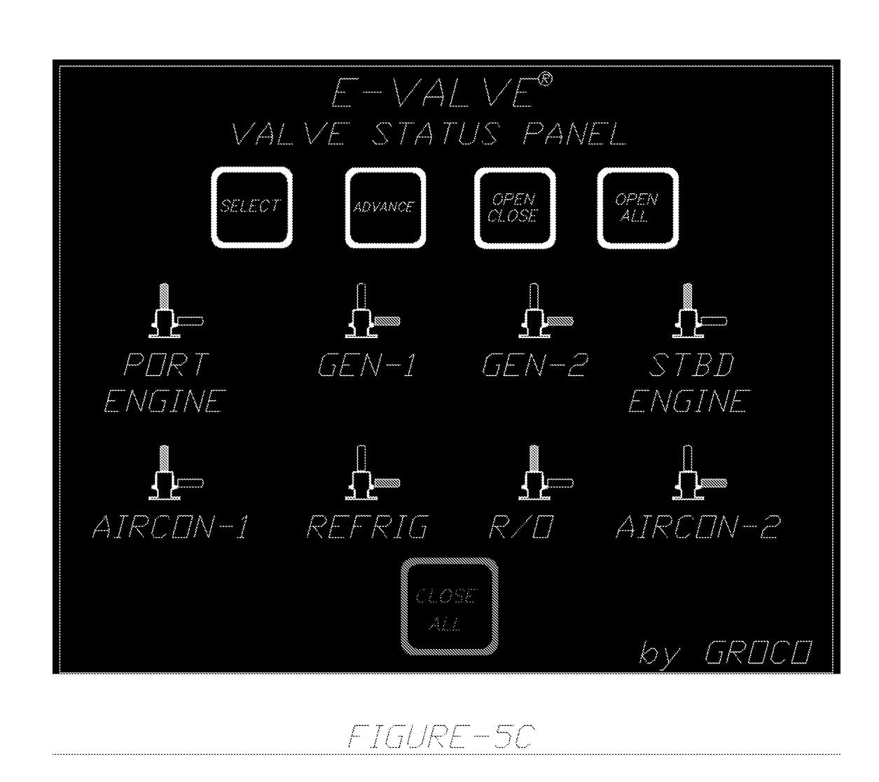

Also optionally, control circuit 400 may contain, or may be interconnected with a transceiver 450 (not shown) (e.g., a system interoperable with NMEA2000, CANbus, Electronic Vessel Control (EVC-Volvo Penta) or SmartCraft standards) to allow remote monitoring of valve state and remote operation of valve 100. A remote panel 500, such as shown in FIG. 5, may be employed to provide status indication and valve control at the helm of the vessel. In its preferred embodiment, panel 500 visually indicates valve status (open, closed, in transit from closed to open, in transit from open to closed, and power failure) and provides a means to initiate operation of valve 100 by transmitting a signal to transceiver 450. Of course, transmission of the signals to and from valve 100 may be wired or wireless, transmitted over any common media and protocol.

As a further option, control circuit 400 may be employed without gear box 300 solely for the purpose of indicating valve status (open or closed).

FIG. 1 shows gear box 300 situated so that motor 310 is on the right side of valve 100. In order to facilitate installation of the valve/gearbox assembly into a confined area, such as against bulkheads or engine stringers, as an additional installation option of the present invention, gearbox 300 may be rotated 180-degrees on the axis of output shaft 230, thus locating gearbox 300 on the left side of valve 100. Control circuit 400 provides a selective means for reversing the position sensing and operation circuitry so that handle 140 rotates 90-degrees clockwise (rather than counterclockwise) to the closed position from the open position, but control 500 continues to function as described earlier.

When more than one valve of the present invention is installed, each valve is uniquely identified and may be individually addressed. FIG. 5c illustrates control panel 500, depicting a multiple seacock system in which Port Engine, Starboard Engine, Air Conditioner-1 and Reverse Osmosis system seacocks are open, while Gen-1, Gen-2, Refrigeration and Air Conditioner-2 seacocks are closed, as indicated by the illuminated portion of the handle 140 of each valve 100. Red illumination on control panel 500 is used to signify a closed (horizontal) handle 140; green illumination on control panel 500 is used to signify an open (vertical) handle 140; yellow illumination on control panel 500 is used to identify a valve (or a group of valves) that is selected for a command. Similarly, solid red and blinking green illumination on any one valve shown on control panel 500 is used to indicate in-transit status from closed to open, and solid green and blinking red on any one valve shown on control panel 500 is used to indicate in-transit status from open to closed. In addition, groups of valves may be defined and addressed with a single command (e.g., open all AIR CONDITIONING valves) and all valves as a group may be commanded, as well (e.g., close ALL valves.) Yellow illumination silhouettes each valve on control panel 500 for the purpose of identifying an individual valve or a group of valves selected to be controlled. In addition, integration with other vessel systems may be accomplished, such that, for example, when a “vessel unattended” status is present, a predetermined set of valves are actuated to close. Also similarly, failsafe commands may be incorporated for safety purposes, tied to logic routines that attempt to provide additional safety margins in the operation of a vessel. (E.g., if the engine is not running and the engine bilge is flooded, then close all engine valves.)

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may be made in the details within the scope and range of equivalents of the claims and without departing from the spirit of the invention. The inventor further requires that the scope accorded the claims to be filed be in accordance with the broadest possible construction available under the law as it exists on the date of filing thereof and that no narrowing of the scope of the appended claims be allowed due to subsequent changes in the law, as such a narrowing would constitute an ex post facto adjudication, and a taking without due process or just compensation.

1. A cam-actuated powered and manually operable valve having a handle for manual valve opening and closing, and a power-driven means for opening and closing, and having both a valve-open ready state and a valve closed ready state, wherein in either ready state, the handle may be manually actuated without disengaging the power-driven means.

2. The valve of claim 1 wherein after powered opening, the cam is power-returned to the valve-open ready state, and after powered closing, the cam is power-returned to the valve-closed ready state.

3. The valve of claim 2 wherein a signal indicative of a desired opening or closing operation is received by the valve, causing the valve to perform the desired operation.

4. The valve of claim 3 wherein the signal is wireless.

5. The valve of claim 1 wherein the power-driven means is an electric motor drive system.

6. The valve of claim 1 wherein the power-driven means is a hydraulic drive system.

7. The valve of claim 1 wherein the cam comprises two faces at substantially right angles, adapted to engage opposite sides of the handle when rotated by the power-drive means.

8. The valve of claim 7 wherein the cam is rotated about 90° from a ready state to change the position of the handle, and thereafter is rotated about 90° in the opposite direction to return to a ready state.

9. A valve system for a vessel comprising one or more cam-actuated powered and manually operable, valves, each having a handle for manual valve opening and closing, and a power-driven means for opening and closing, and having both a valve-open ready state and a valve closed ready state, wherein in either ready state, the handle may be manually actuated without disengaging the power-driven means, and one or more control systems having means to cause the powered operation of each of the valves individually, of a preselected subset of all of the valves, and of all of the valves, and also having a visual indication of the state of each of the valves in the system.

10. The valve system of claim 9 wherein each valve further comprises a battery for powering the valve, and the control system further comprises provides an indication of the state of the battery in each of the valves in the system.

11. The valve system of claim 9 wherein the control system communicates with the valves using a wired network.

12. The valve system of claim 9 wherein the control system communicates with the valves using a wireless network.

13. A method for power operating a manually-operable cam-driven valve comprising the steps of:
a. power rotating the drive cam through about a 90° arc in a first direction to change the state of the valve; and then
b. power rotating the drive cam through about a 90° arc in the opposite direction.
